(19) United States
(12) Patent Application Publication
(10) Pub. No.: US 2011/0216829 A1
(43) Pub. Date: Sep. 8, 2011

(54) ENABLING DELTA COMPRESSION AND MODIFICATION OF MOTION ESTIMATION AND METADATA FOR RENDERING IMAGES TO A REMOTE DISPLAY

(75) Inventor: Vijayalakshmi R. Raveendran, San Diego, CA (US)

(73) Assignee: Qualcomm Incorporated, San Diego, CA (US)

(21) Appl. No.: 13/038,316

(22) Filed: Mar. 1, 2011

Related U.S. Application Data
(60) Provisional application No. 61/309,765, filed on Mar. 2, 2010.

(51) Int. Cl. H04N 7/26

(52) U.S. Cl. 375/240.12; 375/240.01; 375/E07.026

(57) ABSTRACT

Delta compression may be achieved by processing video data for wireless transmission in a manner which reduces or avoids motion estimation by a compression process. Video data and corresponding metadata may be captured at a composition engine. Frame buffer updates may be created from the data and metadata. The frame buffer updates may include data relating to video macroblocks including pixel data and header information. The frame buffer updates may include pixel reference data, motion vectors, macroblock type, and other data to recreate a video image. The macroblock data and header information may be translated into a format recognizable to a compression algorithm (such as MPEG-2) then encoded and wirelessly transmitted.

### CROSS REFERENCE TO RELATED APPLICATION

This application claims the benefit of U.S. provisional patent application No. 61/309,765 filed Mar. 2, 2010, in the name of V. RAVEENDRAN, the disclosure of which is expressly incorporated herein by reference in its entirety.

### BACKGROUND

1. Field

The present disclosure generally relates data compression. More specifically, the present disclosure relates to reducing motion estimation during data compression performed prior to wireless transmission of video signals.

2. Background

Wireless delivery of content to televisions (TVs) and other monitors is desirable. As one example, it may be desirable, in some instances, to have content delivered from a user device for output on a TV device. For instance, as compared with many TV device output capabilities, many portable user devices, such as mobile telephones, personal data assistants (PDAs), media player devices (e.g., APPLE IPOD devices, other MP3 player devices, etc.), laptop computers, notebook computers, etc., have limited/constrained output capabilities, such as small display size, etc. A user desiring, for instance, to view a video on a portable user device may gain an improved audiovisual experience if the video content were delivered for output on a TV device. Accordingly, a user may desire in some instances to deliver the content from a user device for output on a television device (e.g., HDTV device) for an improved audiovisual experience in receiving (viewing and/or hearing) the content.

### SUMMARY

A method for encoding frame buffer updates is offered. The method includes storing frame buffer updates. The method also includes translating the frame buffer updates to motion information in a hybrid compression format, thereby bypassing motion estimation.

An apparatus for encoding frame buffer updates is offered. The apparatus comprising means for storing frame buffer updates. The apparatus also comprises means for translating the frame buffer updates to motion information in a hybrid compression format, thereby bypassing motion estimation.

A computer program product for encoding frame buffer updates is offered. The computer program product includes a computer-readable medium having program code recorded thereon. The program code includes program code to store frame buffer update. The program code also includes program code to translate the frame buffer updates to motion information in a hybrid compression format, thereby bypassing motion estimation.

An apparatus operable for encoding frame buffer updates is offered. The apparatus includes a processor(s) and a memory coupled to the processor(s). The processor(s) is configured to store frame buffer updates. The processor(s) is also configured to translate the frame buffer updates to motion information in a hybrid compression format, thereby bypassing motion estimation.

### BRIEF DESCRIPTION OF THE DRAWINGS

For a more complete understanding of the present disclosure, reference is now made to the following description taken in conjunction with the accompanying drawings.

FIG. 1 is a block diagram illustrating components used to process and transmit multimedia data.

FIG. 2 shows a block diagram illustrating delta compression according one aspect of the present disclosure.

FIG. 3 is a block diagram illustrating macroblock data and header information prepared for wireless transmission.

FIG. 4 illustrates a sample macroblock header for a static macroblock.

FIG. 5 illustrates delta compression according to one aspect of the present disclosure.

### DETAILED DESCRIPTION

The word “exemplary” is used herein to mean “serving as an example, instance, or illustration.” Any aspect described herein as “exemplary” is not necessarily to be construed as preferred or advantageous over other aspects.

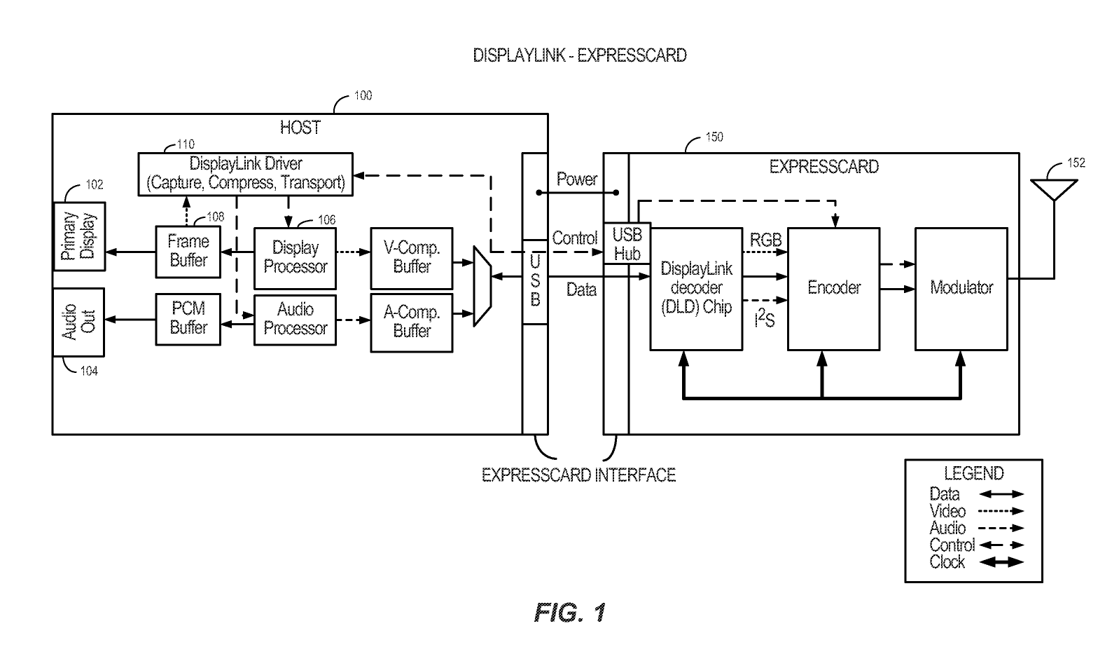

A number of methods may be utilized to transmit video data wirelessly. One such method may utilize a wireless communication device which connects to a content host through an ExpressCard interface as shown in FIG. 1. As shown, a host 100 connects to an ExpressCard 150 through an ExpressCard interface. The host 100 may utilize a number of processing components to process multimedia data for output to a primary display 102 and audio out 104, or the host may process multimedia data for output, through buffers, to a transmitter (shown in FIG. 1 as an external device, such as ExpressCard 150) which may further process the data for eventual wireless transmission over an antenna 152. The logic and hardware shown in FIG. 1 is for illustrative purposes only. Other configurations of hosts, external devices, etc. may be employed to implement the methods and teachings described below.

Commonly, when processing video data, image data is rendered and composed by a display processor 106 and sent to a frame buffer 108, typically in the form of pixel data. That data is then output to a primary display 102. In some situations, video data being output may be from a single source (such as viewing a movie), in other situations (such as playing a video game or operating a device with multiple applications), multiple graphical inputs including graphical overlay objects or enunciators may be combined and/or overlayed onto a video image to create a composite video frame that will ultimately be shown on a display. In the case of multiple video components to be combined, each media processor responsible for generating such video components may have its own output language to communicate video information, such as frame update information, to a composition engine which is used to combine the data from the various inputs/media processors. The composition engine will take the combination of inputs (including video data, graphical objects, etc.) from the various processors, overlay and combine them as desired, compose them into a single image (which may include additional processing such as proper color composition, etc.), and combine them into an image that will eventually be shown on a display.

The inputs from the various processors may be in different language, in different formats, and may have different properties. For example, an input from one device may provide video data at different frame update rates from another. As another example, one device may repeatedly provide new pixel information, while another may only provide video data in the form of pixel updates, which indicate changes from a particular reference pixel(s). Certain processors may also be only operating on different regions of a frame or different types of data which are composed together to create the frame. The various inputs from the different processors are translated to mode information by the composition engine and the inputs from the various processors are converted into pixel data to create the frame. After processing by a composition engine, frame information will be sent to a frame buffer 108 for eventual display.

A common method for wireless transmission of video data is to simply capture the ready-to-display data from the frame buffer 108, encode/compress the video data for ease of transmission, and then send the video data. Such operations may be conducted by a component such as a DisplayLink Driver 110.

One common method of video data compression is MPEG-2, which is discussed herein for exemplary purposes, but other compression standards such as MPEG-4, may also be employed. The use of data compression may employ additional processor and memory capability, may be more time consuming and power consuming, and may lead to a delay in ultimate transmission. Delays may result from a compression process fully decoding a first frame before a next frame using the first frame as a reference may be decoded.

One method for reducing such delays is to process video data for multiple later frames as incremental changes from a reference frame. In such a method update or change information (called delta (A) information or display frame updates) is sent to a display processor for rendering (relative to the reference frame) on the ultimate display. This delta information may be in the form of motion estimation (for example. including a motion vector) or other data. Additional processing power may be employed in calculating such delta information during compression.

In one aspect of the present disclosure, the determining of delta information during compression may be avoided, and/or the processing power dedicated to such determination reduced or avoided. Various media processors (such as those discussed above that output information to a composition engine) may already calculate delta information in a manner such that the delta information may be captured and may not need to be recalculated during compression. By looking at the inputs coming into a composition engine, more raw information on what is happening to each pixel is available. That information may be translated into mode information that an encoder would output for every group of pixels, called a macroblock, or MB. Data for macroblocks in a format understandable by a compression technique (for example, MPEG-2) and header information for the macroblock (which may include motion information) may then be encoded and combined into a compressed bit stream for wireless transmission. In this manner the process of motion estimation and calculation of delta information during traditional compression may be reduced.

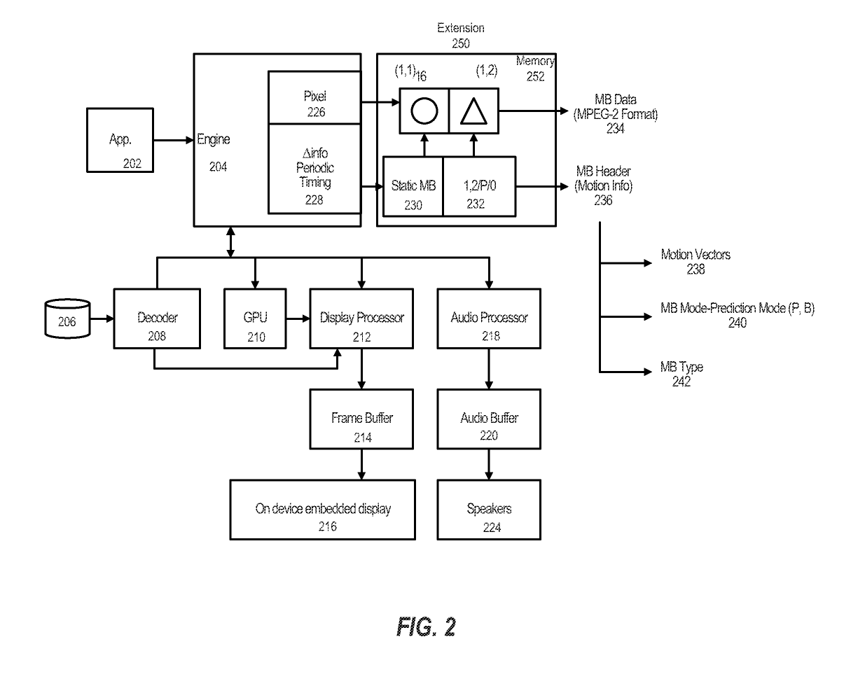

FIG. 2 shows a block diagram illustrating delta compression according one aspect of the present disclosure. Video data from video source(s) 206 may be decoded by a decoder 208 and sent to a display processor 212. From the display processor 212 video data is output to a frame buffer 214 for eventual delivery to an on-device embedded display 216 or to a different display (not pictured). Data from the audio processor 218 is output to an audio buffer 220 for eventual delivery to speakers 224. The display processor 212 may also receive image data from the GPU 210. The GPU 210 may generate various graphics, icons, images, or other graphical data that may be combined with or overlayed onto video data.

An application 202 may communicate with a composition engine/display driver 204. In one example the engine/display driver 204 may be the DisplayLink driver 110 as shown in FIG. 1. The engine 204 commands the display processor 212 to receive information from the GPU 210, decoder 208, and/or other sources for combination and output to the frame buffer 214. As discussed above, in a typical wireless transmission system what is contained in the frame buffer is the final image which is output to the AN encoder and multiplexed prior to transmission.

In the present disclosure, however, the information from the engine 204, rather than the data in the frame buffer, is used to create a wireless output stream. The engine knows the data from the video source(s) 206, GPU 210, etc. The engine is also aware of the commands going to the display processor 212 that are associated with generation of updates to the frame buffer. Those commands include information regarding partial updates of the video display data. Those commands also include graphical overlay information from the GPU 210. The engine 204 traditionally would use the various data known to it to generate frame buffer updates to be sent to the frame buffer.

According to one aspect of the present disclosure, a device component, such as the engine 204 or an extension 250 to the engine 204 may encode frame buffer updates as described herein. The frame buffer updates may be stored in a memory 252 and may comprise metadata. The metadata may include processor instructions. The frame buffer updates may include pixel information. The frame buffer updates may be for frame rate and/or refresh rate. The frame buffer updates may include data regarding an absolute pixel, pixel difference, periodicity, and/or timing. The component may execute hybrid compression, including modification of motion estimation metadata and memory management functions. The hybrid compression may be block based. The frame buffer updates may be split into MB data and MB header.

From the engine 204, primary pixel information 226 and delta/periodic timing information 228 is captured. Metadata may also be captured. Information may be gathered for certain macroblocks (MB). The pixel data 226 may included indices (for example (1,1)) indicating the location of the pixel whose data is represented. From a reference pixel (such as (1,1)) data for later pixels (for example (1,2)) may only include delta information indicating the differences between the later pixels and the earlier reference pixels.

The data captured from the engine 204 may be data intended to go to a main display or it may be intended to go to a secondary display (e.g., video data intended solely for a remote display). Using the described techniques desired pixel data may be captured from any media processor then translated into compression information and sent without traditional motion estimate performed during compression.

In certain situations there may be no changes from one macroblock to the next. When macroblocks do not change from their respective reference macroblocks, they are called static macroblocks. Indication that a macroblock is static may be captured by the engine 204 as shown in block 230. The MB data may be translated into a format recognized by a compression format (e.g. MPEG-2) and output as MB data 234 for transmission. Further information about a macroblock 232 including timing data, type (such as static macroblock (skip), intra (I), predictive (P or B)), delta information, etc. may be translated into a format recognized by a compression format (e.g. MPEG-2) and included as MB header information 236 for transmission. The header information is effectively motion information and may include motion vectors 238, MB mode 240 (e.g., prediction mode (P, B), etc.), or MB type 242 (e.g., new frame).

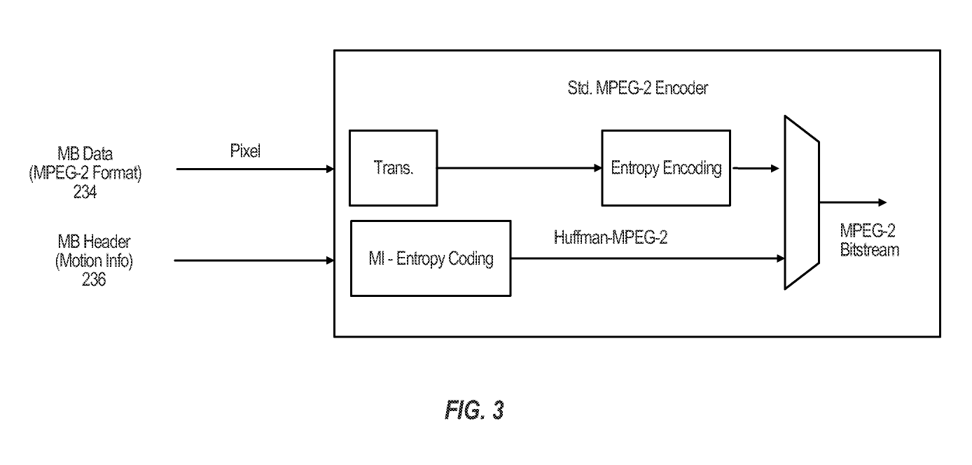

FIG. 3 shows the MB information being prepared for transmission. MB data 234 (which comprises pixel data) is transformed, and encoded before being included in an outgoing MPEG-2 bit stream for wireless transmission. The MB header 236 is processed through entropy coding prior to inclusion in the MPEG-2 bitstream.

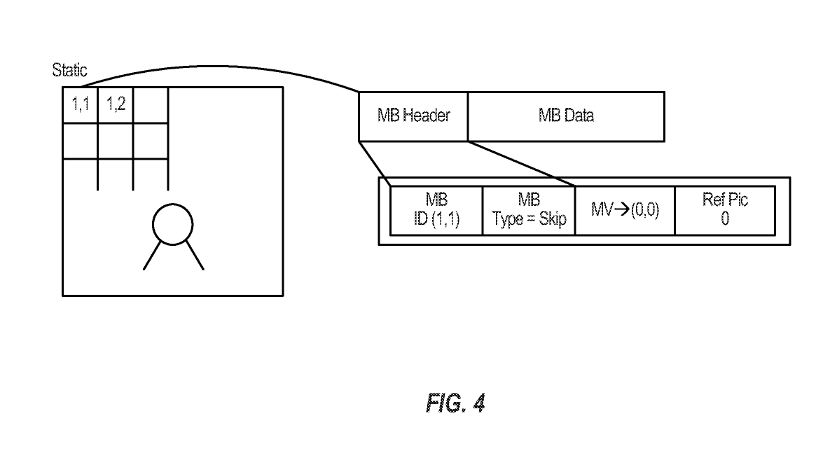

FIG. 4 shows a sample MB header for a static block. In FIG. 4, MB 1,1 is the first macroblock in a frame. The header as shown includes a MB ID (1,1), an MB type (skip), a motion vector (shown as (0,0) as the MB is static), and showing a reference picture as 0.

In the process described above in reference to FIGS. 2 and 3, the motion estimation performed during traditional compression prior to transmission is reduced or eliminated. Delta information available at a display processor 212 is typically not compressed. Should motion data be desired from the display processor 212 be desired for transmission as above, the delta information may be translated/encoded into a format understandable by a compression technique (for example, MPEG-2) or otherwise processed. Once translated, the delta information may be used in combination with reference frames as described above.

Because motion estimation may be between 50-80% of the total complexity of traditional compression, removing motion estimation results in improved efficiency, reduced power consumption, and reduced latency when wirelessly transmitting video data.

For example, MPEG-2 encoding in customized hardware (such as an application-specific integrated circuit (ASIC)) may consume 100 mW for HD encoding at 720 p resolution (or even higher for 1080 p). The techniques described herein for delta MPEG-2 compression may reduce this figure significantly by reducing compression cycles/complexity proportional to entropy in the input video. In particular, the techniques described herein take advantage of the large number of video frames that do not need updates.

As described below, even with video traditionally considered to have lots of movement, there is a sufficiently large percentage of MBs that are static (defined as no movement vector as in collocated macroblock, zero residuals, previous picture as reference) on a frame-by-frame basis:

TABLE 1
Proportion of Static MBs in Video

| | % of | % of frames with |
|---|---|---|
| Content | Static MBs | >80% Static MBs |
| ESPN News | 85.04% | 91.43% |
| Weather | 83.21% | 79.29% |
| CNN News | 88.59% | 92.14% |
| Bloomberg News | 84.61% | 85.71% |
| Animation | 87.79% | 90.71% |
| MTV | 55.08% | 2.14% |
| HBO | 36.73% | 0.71% |
| Music Video | 16.25% | 0.00% |
| Baseball | 35.69% | 0.00% |
| Football | 33.50% | 0.00% |
| Average: | 60.65% | |

Table 1 shows data resulting from a sampling of over thirty different ten-minute sequences captured from digital TV over satellite. From the sampled programming, on average 60% of video contains static macroblocks which do not need to be updated on a display. The third column of Table 1 also shows that in news and animation type video, over 80% of the frame does not need to be updated more than 80% of the time. Enabling an encoder to process just the updates or a portion of the frame rather than the entire frame may result in significant power savings. This could be done some of time to start with (e.g., when more than 80% of the frame contains static MBs).

A significant percentage of the video content falls in the category of news or animation (i.e., low motion, low texture):

TABLE 2
Video Categorization based on Motion and Texture

| | Proportion of the |
|---|---|
| Content Type | sample set |
| Low Motion, Low texture | 47% |
| Med motion, medium texture | 17% |
| High motion, high texture | 36% |

Applying appropriate redundancy in video to optimize (or reduce) video processing load, and identification of mechanisms (for example using skip or static information) will assist for low power or integrated application platforms.

During traditional motion estimation and compensation, a large amount of data is fetched and processed, typically interpolated to improve accuracy (fractional pixel motion estimation), before a difference metric (sum of absolute differences (SAD) or sum of squared differences (SSD)) is computed. This process is repeated for all candidates that can be predictors for a given block or MB until a desired match (lowest difference or SAD) is obtained. The process of fetching this data from a reference picture is time consuming and constitutes a major factor for processing delays and computational power. Typically the arithmetic to compute the difference is hand coded to reduce the number of processor cycles consumed. However, since the data to be fetched can vary widely in location (closest to farthest MB in the frame over multiple frames if multiple reference picture prediction is used) and may not be aligned with MB boundaries, memory addressing adds additional overhead. Also, the data fetched for the previous MB may not be suitable for the current MB which limits optimizations for data fetch and memory transfer bandwidths.

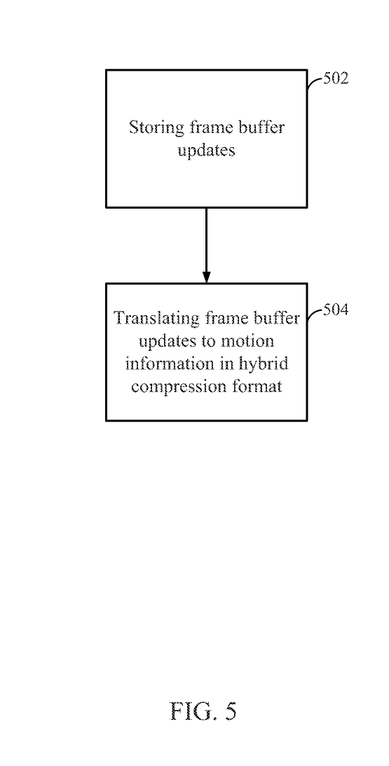

FIG. 5 illustrates delta compression according to one aspect of the present disclosure. As shown in block 502, frame buffer updates are stored. As shown in block 504, frame buffer updates are translated to motion information in a hybrid compression format, thereby bypassing motion estimation.

In one aspect an apparatus includes means for storing frame buffer updates, and means for translating frame buffer updates to motion information in a hybrid compression format. The device may also include means for capturing a timestamp for a user input command and means for capturing corresponding display data resulting from the user input command. In one aspect the aforementioned means may be a display driver 110, an engine 204, a frame buffer 108 or 214, a memory 252, an engine extension 250, a decoder 208, a GPU 210, or a display processor 106 or 212.

Although the present disclosure and its advantages have been described in detail, it should be understood that various changes, substitutions and alterations can be made herein without departing from the technology of the disclosure as defined by the appended claims. Moreover, the scope of the present application is not intended to be limited to the particular aspects of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or steps.

What is claimed is:

1. A method for encoding frame buffer updates, the method comprising:
storing frame buffer updates; and
translating the frame buffer updates to motion information in a hybrid compression format, thereby bypassing motion estimation.

2. The method of claim 1 in which the frame buffer updates comprise pixel information and metadata.

3. The method of claim 2 in which the metadata comprises processor instructions.

4. The method of claim 1 in which the hybrid compression format is block based.

5. The method of claim 4 in which the frame buffer updates contain a macroblock header and macroblock data.

6. The method of claim 5 in which the macroblock header comprises at least one of a macroblock ID, macroblock type, motion vector, and reference picture.

7. The method of claim 6 in which the macroblock type includes a macroblock mode and the macroblock mode is one of static macroblock (skip), intra (I), and predictive (P or B).

8. The method of claim 5 in which the macroblock header and macroblock data are in an MPEG-2 recognizable format.

9. The method of claim 5 in which the macroblock data includes pixel difference data and absolute pixel data.

10. The method of claim 5 in which the macroblock header includes periodicity and timing data.

11. An apparatus for encoding frame buffer updates, the apparatus comprising:
means for storing frame buffer updates; and
means for translating the frame buffer updates to motion information in a hybrid compression format, thereby bypassing motion estimation.

12. A computer program product for encoding frame buffer updates, the computer program product comprising:
a computer-readable medium having program code recorded thereon, the program code comprising:
program code to store frame buffer updates; and
program code to translate the frame buffer updates to motion information in a hybrid compression format, thereby bypassing motion estimation.

13. An apparatus operable to encode frame buffer updates, the apparatus comprising:
at least one processor; and
a memory coupled to the at least one processor, the at least one processor being configured:
to store frame buffer updates; and
to translate the frame buffer updates to motion information in a hybrid compression format, thereby bypassing motion estimation.

14. The apparatus of claim 13 in which the frame buffer updates comprise pixel information and metadata.

15. The apparatus of claim 14 in which the metadata comprises processor instructions.

16. The apparatus of claim 13 in which the hybrid compression format is block based.

17. The apparatus of claim 16 in which the frame buffer updates contain a macroblock header and macroblock data.

18. The apparatus of claim 17 in which the macroblock header comprises at least one of a macroblock ID, macroblock type, motion vector, and reference picture.

19. The apparatus of claim 18 in which the macroblock type includes a macroblock mode and the macroblock mode is one of static macroblock (skip), intra (I), and predictive (P or B).

20. The apparatus of claim 17 in which the macroblock header and macroblock data are in an MPEG-2 recognizable format.

21. The apparatus of claim 17 in which the macroblock data includes pixel difference data and absolute pixel data.

22. The method of claim 17 in which the macroblock header includes periodicity and timing data.
